(19) United States
(12) Patent Application Publication
(10) Pub. No.: US 2021/0154658 A1
(43) Pub. Date: May 27, 2021

(54) Method and System to Improve All Phases of Ion-Exchange Resin Regeneration

(71) Applicant: Abdullah Kazi, Yorba Lindo, CA (US)

(72) Inventor: Abdullah Kazi, Yorba Lindo, CA (US)

(21) Appl. No.: 15/733,724

(22) PCT Filed: Feb. 7, 2019
(86) PCT No.: PCT/US19/17111

§ 371 Date: Oct. 5, 2020

Related U.S. Application Data
(60) Provisional application No. 62/627,673, filed on Feb. 7, 2018.

(51) Int. Cl. B01J 49/09; B01J 47/04; B01J 47/11; B01J 49/60; B01J 49/85

(52) U.S. Cl. CPC B01J 49/09; B01J 47/04; B01J 49/85; B01J 49/60; B01J 47/11

(57) ABSTRACT

A semi-continuous or continuous method and system to improve all phases of ion-exchange resin regeneration such as backwash, resin separation, chemical treatment, slow rinse, fast rinse, resin mixing, and final QA/QC to reduce, reuse and recycle water and chemicals employed in ion-exchange resin regeneration operations. Aqueous media quality is controlled in both backwash as well as ion-exchange resin separation.

### BACKGROUND OF THE INVENTION

### Technical Field

The present invention relates most generally to fluid treatments, and more particularly to ion-exchange fluid treatment systems, and still more particularly to a system and method for regenerating ion-exchange resin.

### Background Art

Water is well known as a universal solvent. It dissolves inorganic minerals as solutes. Inorganic minerals dissolved in water tend to ionize and produce positively charged ions (cations) and negatively charged ions (anions). Beside inorganic minerals, water tends to have several other naturally occurring organic impurities and suspended solids. Thus, natural water supply (ground water supply or surface water supply) typically contains both suspended solid and dissolved minerals as impurities.

Inorganic solutes may be removed from water in a number of steps, including the step of using an ion-exchange resin. Organic impurities are removed with activated carbon. Suspended solids are removed by filtration. To obtain water in the purest form, all three processes are employed. Other chemical and mechanical separation processes may also be used, including distillation and reverse osmosis.

Typically, water is first treated to remove suspended solids by filtration technology, then it is passed through activated carbon bed to remove organic impurities with adsorption technology and finally it is passed through ion-exchange resin to remove the ionic impurities through ion-exchange technology. This removal of ionic impurities is accomplished by either dual beds of cation and anion-exchange beds (two separate vessels) or mix-bed ion-exchange resin in single vessel.

Broadly stated, ion-exchange systems use one of two kinds of ion-exchange resins: either cation or anion. The ion exchange resins are generally formed as membranes or beads in the form of organic polymers. Cation exchange resins typically employ surfaces having exposed functional groups of strong or weak acids, while anion exchange resins use strong or weak base groups.

In regenerated form the resins are employed to make deionized water for industrial applications. There are two types of processes for producing deionized water. In a first type, both kinds of ion-exchange resin (in regenerated form) are placed in separate vessels, and deionized water is produced by passing water through a cation vessel followed by passing it through an anion vessel. This type of deionized water is considered and termed “low quality” deionized water, based on water resistivity measurements, i.e. using the water's resistance to electric current.

In the second type, both ion-exchange resins (cation and anion) are combined in regenerated form in a mix-bed and placed in single vessel. When water is passed through this single mix-bed vessel, “high quality” deionized water is produced.

When water is passed through an ion-exchange bed, the ion-exchange bed acts as a filter media, and the suspended particles trapped in the resin bed contaminate the resin, reduce the resin bonding capacity, and produce flow restrictions. Similarly, the minerals in dissolved form dissociate into cations and anions, which are exchanged with ion-exchange resin cations and anions. After a certain amount of water flow through the resin bed, and thus after repeated treatment cycles have removed unwanted ions (contaminants), the resin becomes fouled, exhausted, depleted, or “spent”, and its ion-exchange capacity is reduced by becoming coated with ions that have been “exchanged” from the water onto the resin. Consequently, the ion-exchange resin beds need regeneration, firstly using a backwash to fluidize trap suspended particles and free the ion-exchange resin from the undesired suspended particles, and secondly using a chemical treatment to regenerate the depleted ion-exchange resin.

At present, an entire regeneration cycle can be summarized as comprising the following essential steps: (a) backwashing the ion-exchange resin bed; (b) mix-bed separation/isolation into anion and cation-exchange resins; (c) alkaline chemical treatment of anion-exchange resin, followed by thorough rinsing; (d) acidic chemical treatment of cation-exchange resin, followed by thorough rinsing; and, finally (e) remixing of anion and cation-exchange resins for reuse to produce de-ionized water. Through these method steps, chemically treated mix-bed ion-exchange resin is restored and the ion-exchange capabilities of the resin are regenerated.

These steps have been refined and the regeneration process has matured considerably in recent decades. However, despite its widespread industrial use over even the last century, and while research and development have revealed and introduced improved ion-exchange resins to the market, there have been few improvements in the ion-exchange resin regeneration processes. Current regeneration processes utilize the same batch treatment, require the same amount of regenerant chemicals, and employ the same enormous quantities of water with little consideration given to recycling, reuse, or conservation.

### DISCLOSURE OF THE INVENTION

The present invention is directed to improvements in ion-exchange resin regeneration. The focus of the improvements is in five critical steps: resin backwash; mixed-bed resin separation (if applicable); anion-exchange resin chemical treatment and rinsing; cation-exchange resin and rinsing; and final QA/QC. Each step of the process is addressed separately below. Collectively, the improvements achieve economic and environmental benefits in chemical conservation and water conservation.

In ion-exchange regeneration, resin backwash is typically implemented using a resin bed volume expansion of 100%. This bed volume expansion is carried out with upward flow of water at a rate of 7-12 gpm/ft². At this flow rate, the ion-exchange resin is freed from silt, dirt particles, and the ion-exchange resin fines. The presence of these undesired particles tends to reduce the ion-exchange capacity and also creates unnecessary operating pressure during the service cycle. Backwash effectiveness may be facilitated by using compressed air bubbled through the resin bed, which creates a scrubbing effect to dislodge undesired particles from the resin surface. This backwash process also creates a uniform resin bed and destroys resin glomeration, which compromises the use of full resin capacity during the operating cycle.

At the backwash flow rate of 7-12 gpm/ft² a considerable volume of wastewater is produced. Until relatively recently, the creation of backwash wastewater and its disposal was not an issue, but the recovery and recycling of water has become critical, both economically and environmentally. Thus, the present invention uses its many process improvements to achieve water recycling levels of up to 95-98% from backwash wastewater.

The improved process and system for the separation and isolation of anion and cation-exchange resins is especially adapted a mix-bed form. The improved process and system increases treatment capacity and consequently reduces the cost of making deionized water.

As used herein, the term “separation” refers to the bulk classification of resins within a single vessel or zone. The term “isolation” refers to the transfer of resins so that they occupy separate zones.

In an embodiment of the invention, the intermediate density liquid is an aqueous solution of an alkali metal hydroxide, most preferably sodium hydroxide. Such a solution has a particular advantage that it regenerates the anion-exchange resin at the same time that it separates the anion-exchange resin from cation resin contaminants. Because the sodium hydroxide solution will be fairly concentrated (i.e. generally in the range of about 10 to 20 weight percent) a very high level of regeneration will be achieved.

The inventive system carries out chemical treatment in such a manner as to ensure thorough contact of chemical with spent anion or cation-exchange resin, thereby allowing it to regenerate with higher exchange capacity by allowing more contact time of chemical via dynamic chemical equilibrium phenomenon with spent anion or cation-exchange resin.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a highly schematic flow diagram of the backwash apparatus of the present invention;

FIG. 2 is a schematic flow diagram of a semi-continuous resin separation apparatus;

FIG. 3 is a schematic flow diagram of a continuous resin separation apparatus;

FIG. 4 is a schematic flow diagram featuring a single vertical vessel with a single header for use in a continuous resin separation apparatus of the present invention, also featuring a baffle system disposed centrally within the recycled water vessel;

FIG. 5 is the same view showing an embodiment with the baffle system disposed proximate or against an interior wall of the backwash vessel;

FIG. 6 is again the same view as that of FIG. 4, with the system including centrally disposed agitators;

FIG. 7 is the same view as that of FIG. 5, showing the system with a centrally disposed agitator;

FIG. 8 is a schematic top plan view showing a circular multi-tank configuration for the semi-continuous resin separation apparatus;

FIG. 9 is a schematic view showing a linear configuration of a conveyor belt embodiment of the semi-continuous resin separation apparatus;

FIG. 10 is a schematic view showing resin transfer flow in a direction opposing the direction of flow of a chemical in six stationary vessels arranged in a circular manner in the continuous resin separation apparatus;

FIG. 11 illustrates the transfer of resin in an opposite direction to the flow of a chemical in six stationary vessels arranged in a linear array in the continuous resin separation apparatus;

FIG. 12 illustrates the continuous resin separation apparatus with a transfer of resin in an opposite direction to the flow of a chemical in six-compartment stationary tank;

FIG. 13 is a table showing an embodiment of a 0.5 bed volume chemical treatment schedule;

FIG. 14 is a table showing a 1.0 bed volume chemical treatment schedule;

FIG. 15 is a table showing a 2.0 bed volume chemical treatment schedule;

FIG. 16 is a table showing the number of chemical treatments each vessel has received in a 2 bed volume chemical treatment after 6-10 chemical rinses; and

FIG. 17 is a table showing the number of chemical treatments each vessel has received in a 2 bed volume chemical treatment after 11-16 chemical rinses.

### BEST MODE FOR CARRYING OUT THE INVENTION

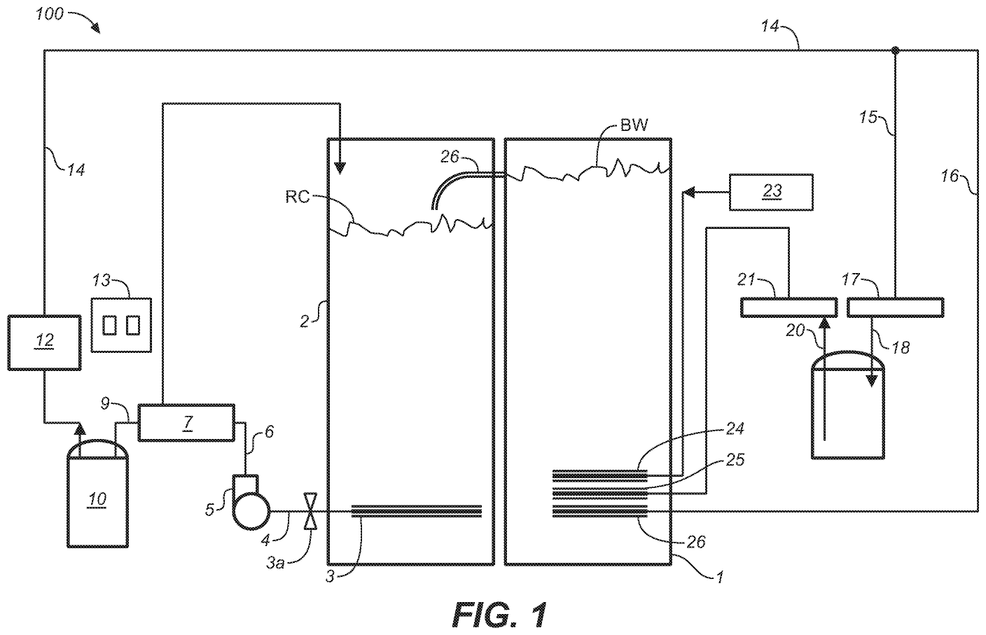

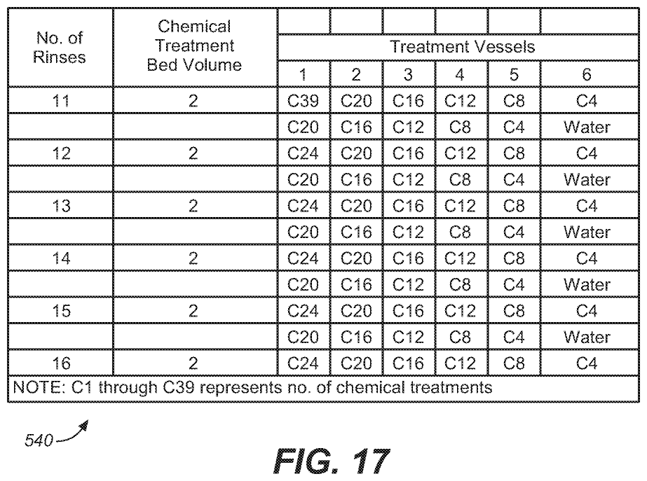

Referring to FIGS. 1 through 17, wherein like reference numerals refer to like components in the various views, there is illustrated therein a new and improved method and system for improving ion-exchange resin regeneration.

The invention will be described figure by figure as it is applied to the improvements in all phases of ion-exchange resin regeneration. Such might be applied in other industrial operations where chemical treatment and rinsing can be adopted using the knowledge of this invention. For example, this invention can be applied to the extraction of gold from its ore in the gold mine industry where the ore is chemically treated to extract gold. The gold extracted ore needs to be rinsed in order to set it free from the chemicals. The chemical free gold extracted ore would then be disposed properly to meet the environmental compliance.

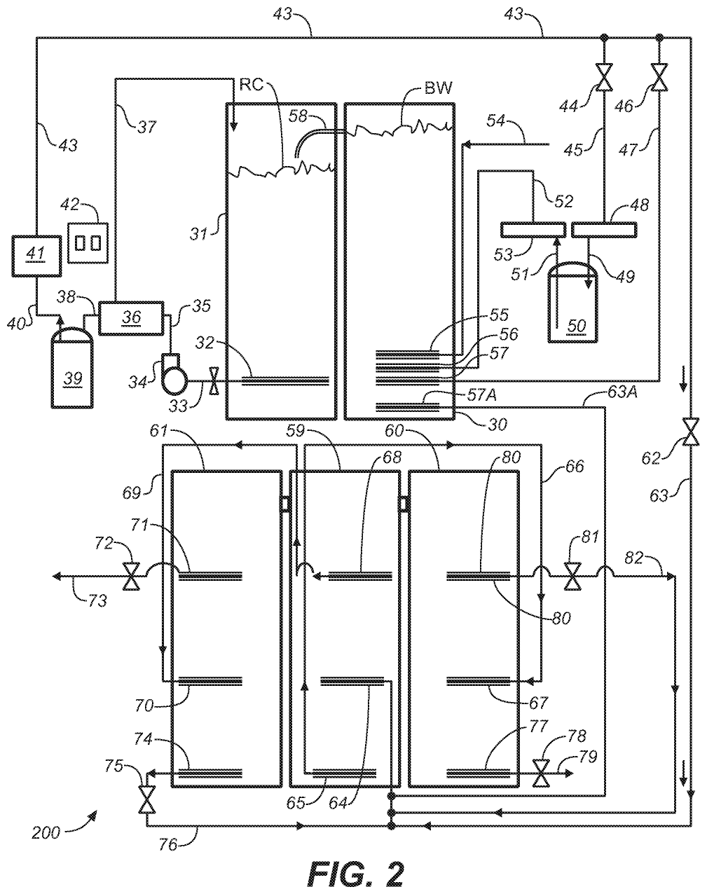

In various backwash and resin separation apparatuses the quality controlled water is employed, which is identical and common in all figures from 1 through 8. This quality controlled water is described as follows in FIG. 1. Conduit 4 equipped with shut off valve 3a draws water from a recycled water reservoir 2 and delivers it to pump 5. Conduit 6 receives the water from pump 5 and delivers it to micro-filtration unit 7. The micro-filtration unit 7 splits the incoming water into conduit 8 and conduit 9. Conduit 9 delivers water to water softening vessel 10 and conduit 8 returns water back to the reservoir. Conduit 11 collects the water from water softening vessel 10 and delivers it to water quality monitoring system 12, which measures the resistivity of the water. The water quality controlled data is recorded in recorder 13. Conduit 14 then delivers the water to various backwash and resin separation equipment. Similar processes are followed in FIGS. 2-8.

Backwash vessel 1 contains backwash water, while recycled water vessel 2 is the main source of recycled water RC and feeds recycled water through conduit 4 first into the water treatment system described above, and then into the backwash system through conduit 14. Conduit 14 splits into delivery conduits 15 and 16. Delivery conduit 15 delivers water to header 17, and conduct 18 thereafter collects the water from header 17 and delivers it to spent resin vessel 29. The flow of water into spent resin vessel 29 fluidizes spent resin, which is carried through conduit 20 to header 21. Conduit 22 collects the fluidized spent resin from header 20 and delivers it to header 25, disposed in backwash vessel 1, which then distributes the spent resin into the vessel. A compressed air system 23 delivers compressed air to header 24, also disposed in backwash water vessel 1.

Simultaneously, delivery conduit 16 delivers a flow of filtered and softened recycled water directly to header 26 situated in backwash vessel 1. Header 3 disposed in recycled water reservoir 2. Collects the water delivered into the system through conduit 4 when the shut-off valve 3a is open. The backwash water BW from backwash vessel 1 overflows into recycled water vessel 2 through conduit 26.

The system shown is a closed system, but as water is naturally lost through use, make-up water (e.g., city water) can be introduced directly into vessel 2.

FIG. 2 illustrates an embodiment 200 of a semi-continuous resin separation apparatus for the present invention. The backwash system of FIG. 1 is essentially incorporated, as seen, with vessels 30 and 31 of FIG. 2 corresponding, respectively, to vessels 1 and 2 of FIG. 1.

Recycled water RC from recycled water vessel 31 is pulled by pump 34 through header 32 disposed in recycled water vessel 31 and conduit 33 when shut-off valve 33a is open, where the water flow is then delivered by conduit 35 to microfiltration unit 36, through conduit 38 to and through softener 39, and then to water quality monitor 41, where data is collected by controller 42.

After water quality measurement, water then flows through conduit 43 and is divided into three conduits: conduits 45, 47 and 63. Forward flow is controlled by a shut-off valve for each conduit, 44, 46, and 62, respectively. Conduit 45 delivers water to header 48. Conduit 49 collects the water from header 48 and delivers it to spent resin vessel 50 where fluid flow fluidizes spent resin and carries it through conduit 51 to header 53. Conduit 52 collects fluidized spent resin from header 53 and delivers it to header 56 located in backwash water vessel 30. Compressed air system 54 delivers compressed air to the header 55, also disposed in backwash water vessel 30.

Conduit 47 delivers a flow of treated water directly to backwash vessel 30 through header 57. The backwash water BW from backwash water vessel 30 overflows into recycled water vessel 31 through conduit 58.

Conduit 63 delivers a flow of a portion of water from the divided water flow of conduit 43 through shut-off valve 62 to header 64 situated in a first resin separation vessel 59. Additionally, backwashed mixed spent resin from header 57A in backwash vessel 30 is also transferred to header 64 in first resin separation vessel 59 through conduit 63A. Header 65 disposed in the bottom of first resin separation vessel 59 transfers spent cation exchange resin to header 67 situated in second resin separation vessel 60 through conduit 66. Header 80, also located in second resin separation vessel 60 transfers anion resin through valve 81 and conduit 82 to header 64.

Concurrently, spent anion resin is transferred from header 68 of first resin separation vessel 59 to header 70 located in a third resin separation vessel 61 through conduit 69. Header 74 at the bottom of third resin separation vessel 61 transfers spent cation resin from third resin separation vessel 61 through shutoff valve 75 and conduit 76 to header 64 in first resin separation vessel 59. Finally, the spent anion resin is transferred from third resin separation vessel 61 through header 71 and conduit 73 for further chemical treatment. The spent cation resin from the second resin separation backwash vessel 60 is collected by header 77 and conducted through conduit 79.

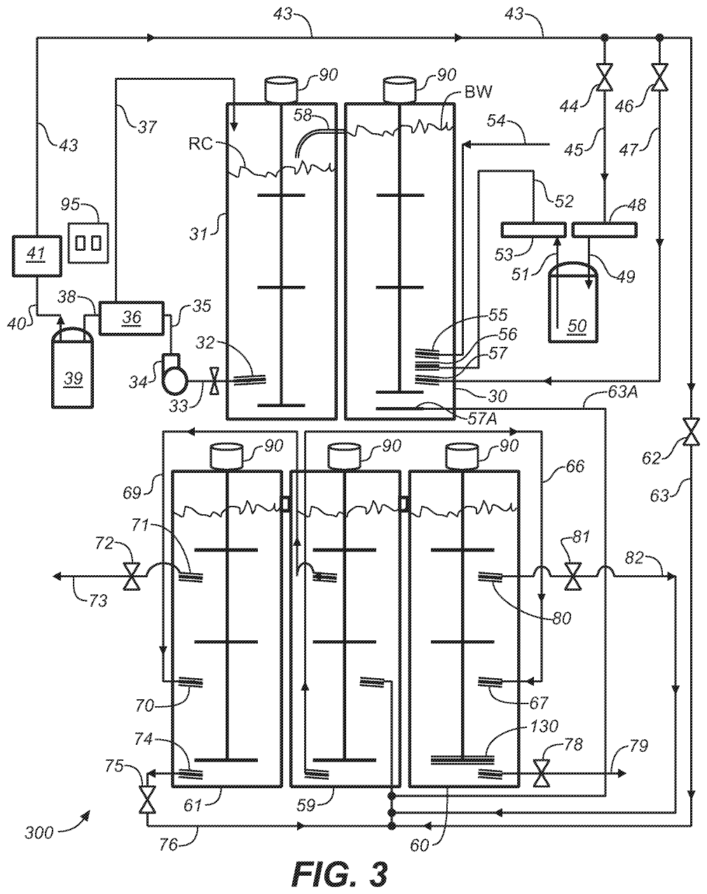

FIG. 3 illustrates the apparatus of this invention for a continuous resin separation process 300 utilizing the five vessel configuration shown in FIG. 2, the salient difference being the inclusion of mechanical agitators 90 on each tank.

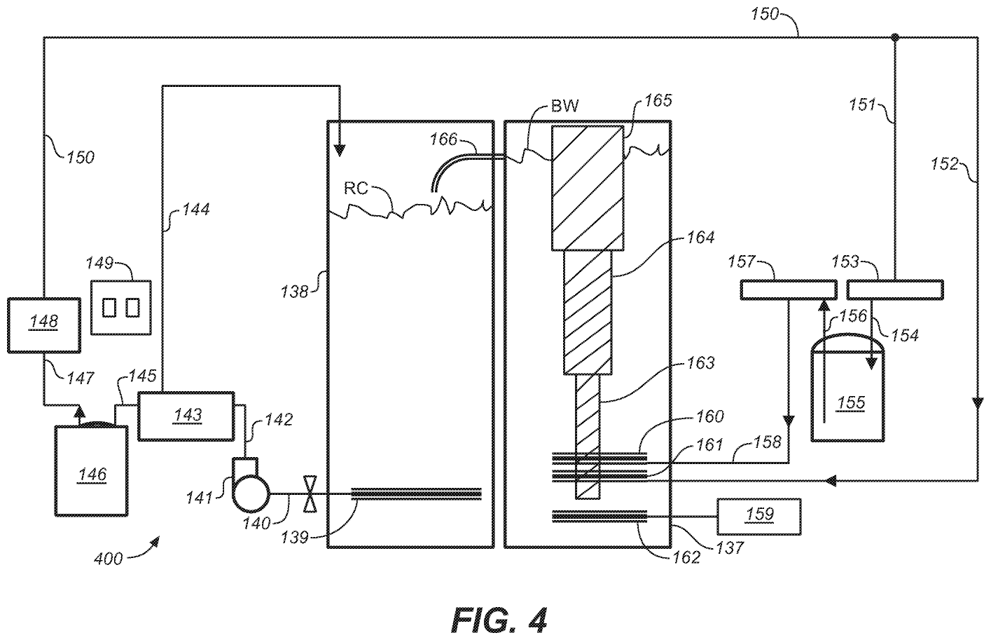

FIG. 4 shows an embodiment 400 of a continuous resin separation system and process 400 for the present invention, which is a variation on the system of FIG. 1. This system utilizes a single vertical vessel 137 equipped with a single header 139. Axially disposed in the center of vessel 137, assuming a cylindrical vessel shape, there are three baffles 163, 164, 165, schematically depicted as cylinders of varying and increasing size. These variously sized objects function as baffles to affect fluid flow velocities in a predetermined manner. As will be appreciated, they may be any of a number of suitable shapes depending on the desired effect on fluid flow characteristics. The lowest baffle 163 occupies the least volume (displaced the least volume of fluid), while the uppermost 165 occupies the maximum volume. The purpose of the variably shaped baffles is to create variable fluid flow velocities in their respective zones within the vessel. If header 160 introduces a flow of water at a low flow rate, e.g., 2 gpm, then in an embodiment the lowest baffle 163 may be sized to increase the flow in that zone, for example, to 3.5 gpm. The middle baffle 164 may be sized to increase the fluid flow from 3.5 gpm to, 5.5 gpm, as an example. Finally, the uppermost baffle 165 may be sized to increase the velocity from 5.5 to 12 gpm. These variable velocity zones enhance and effect backwash and resin separation.

Still referring to FIG. 4, as seen in the view, conduit 150 divides its flow into two conduits, conduit 151 and conduit 152. Conduit 151 conducts water to header 153. Conduit 154 collects the water from header 153 and forwards it to spent resin vessel 155. The flow of water into spent resin vessel 155 fluidizes spent resin, carries it through conduit 156, and delivers it to header 157. Conduit 158 directs fluidized spent resin from header 157 to header 160 situated in backwash vessel 137. Compressed air system 159 delivers compressed air to header 162 situated in backwash vessel 137. Conduit 152 delivers a flow of treated (filtered and softened) recycled water directly to header 161 situated in backwash vessel 137. Header 139 is situated in recycled water reservoir 138 which is again the main source of recycled water and which supplies water to the system through conduit 140. The backwash water BW from backwash vessel 137 overflows into recycled water reservoir 138 through conduit 166.

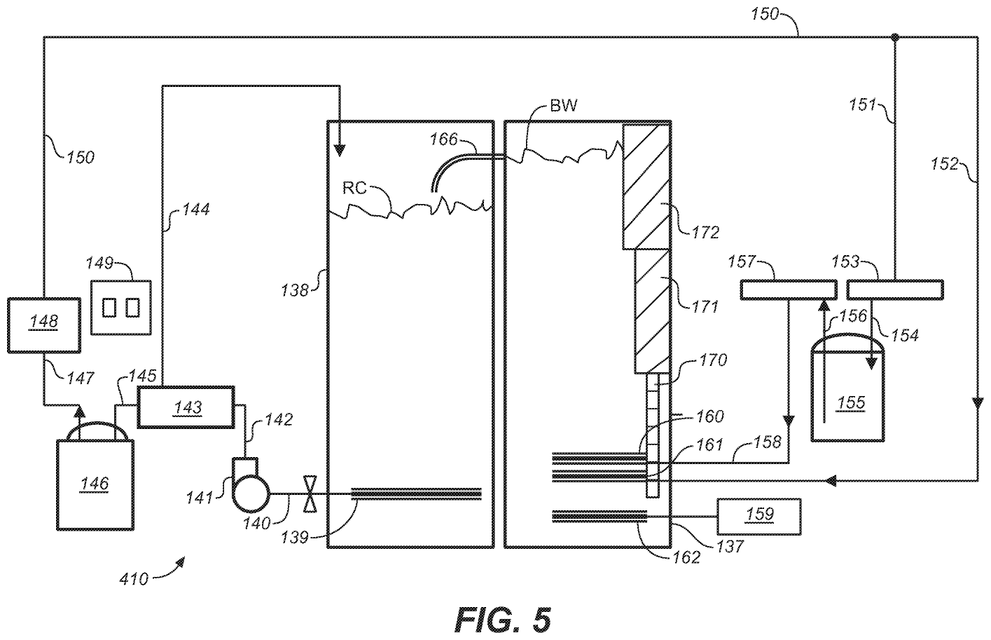

FIG. 5 is the same system and process as that shown in FIG. 4, with the exception that three baffle members centrally disposed in the backwash vessel in the system of FIG. 4 are denominated as baffles 170, 171, 172, and they are disposed against or proximate to an interior wall of the backwash vessel 137.

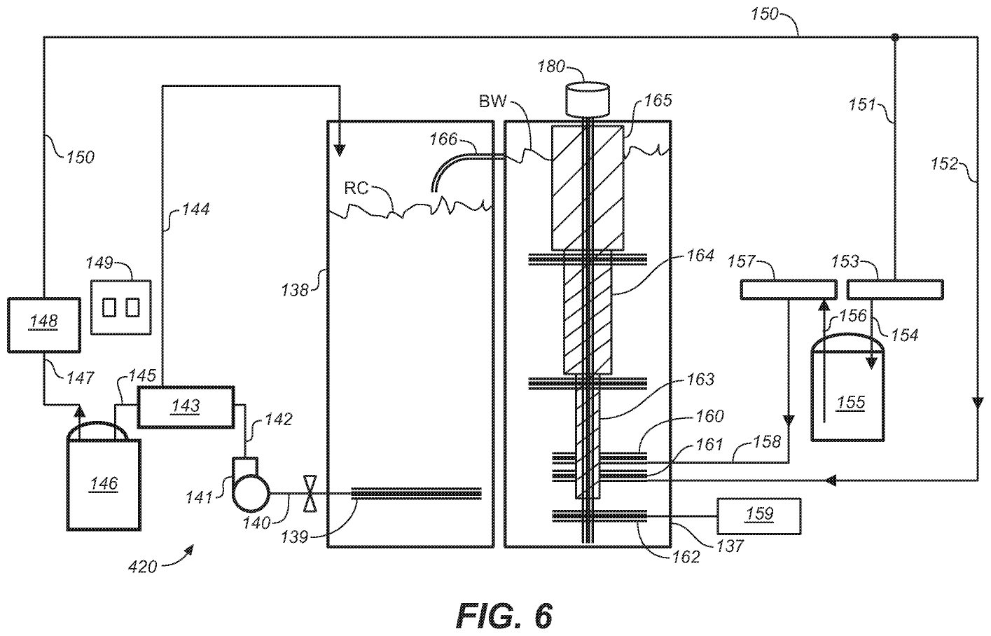

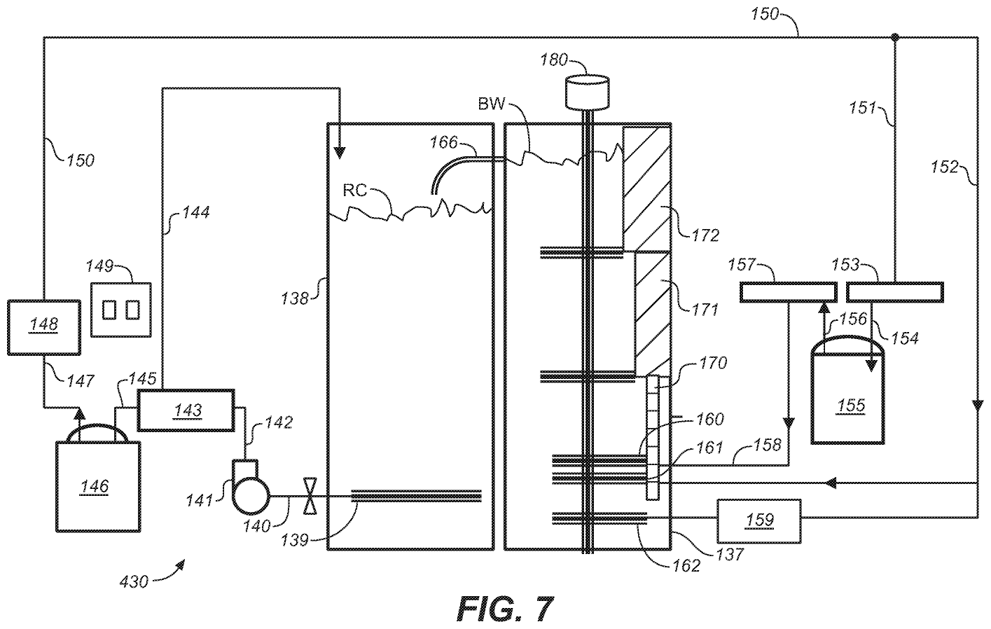

The system and apparatus of FIG. 6 and FIG. 7 correspond, respectively, to those of FIG. 4 and FIG. 5. Shown here, however, are distinct embodiments 420, 430, in which mechanical agitators 180 are disposed. Mechanical agitators and compressed air complement each other in effecting resin separation. It will be noted, however, that mechanical agitators provide a more uniform and controlled agitation while compressed air bubbles may or may not produce uniform agitation. Thus each agitation system may be used selectively, alone or in combination.

In an embodiment, the continuous resin separation system of the present invention can be configured as a horizontally oriented, multi-compartment unit having a plurality of tanks corresponding to the vertically oriented configurations discussed above. For instance, in an embodiment, such a unit might have four major compartments, each divided into primary and secondary sub-compartments, for a total of eight (8) distinct compartments. The secondary sub-compartments are interconnected and in fluid communication with one another, and the primary sub-compartments are provided with headers that uniformly deliver incoming water to the primary compartments. A partition separates each primary compartment from its respective sub-compartment. The partition establishes a velocity gradient in the primary compartment, wherein the velocity at the bottom of the primary compartment gradually increases to the top, where the fluid finally overflows to the respective secondary compartment

A first of the major compartments receives mix-bed spent resin for separation. The mix-bed spent resin is uniformly distributed on the surface of the first major compartment using a uniform velocity of controlled chemistry aqueous media within the compartment. The gradual increase in velocity of aqueous media starts working and backwashing then goes into effect. The dirt particles and resin fines do not settle in this compartment; rather, together with aqueous media they are carried in to the corresponding first secondary compartment. Therefore, the fundamental function of the first major compartment is to carry out backwash.

The first major compartment is provided with a resin transfer system that transfers the resin into the primary compartment of a third major compartment. The third major compartment is configured around a similar principle to that of the first major compartment, which provides variable increasing velocity of aqueous media. The third major compartment provides volume at the bottom of its primary sub-compartment that allows cation resin to settle and remain at the bottom of the primary sub-compartment of the third major compartment; anion resin will occupy the upper layer. Continuously, the mix bed from the first primary compartment is delivered to the third primary sub-compartment in the “fuzzy band zone” where anion resin and cation resin are both present. Thus, continuously the cation resin keeps moving in the downward direction and continuously anion resin movies in the upward direction, thereby coarsely separating spent cation resin and spent anion resin. This compartment is equipped with two transfer headers: a first that continuously transfers cation resin to the primary sub-compartment of the second major compartment, and the other transfers anion resin continuously to the primary sub-compartment of a fourth major compartment.

The second and fourth primary sub-compartments, are responsible for fine separation, wherein two headers transfer continuously finely separated anion and cation resin to a next chemical treatment operation. Both the second and fourth major compartments are provided headers that transfer poorly separated resin back to the third major compartment for further course separation.

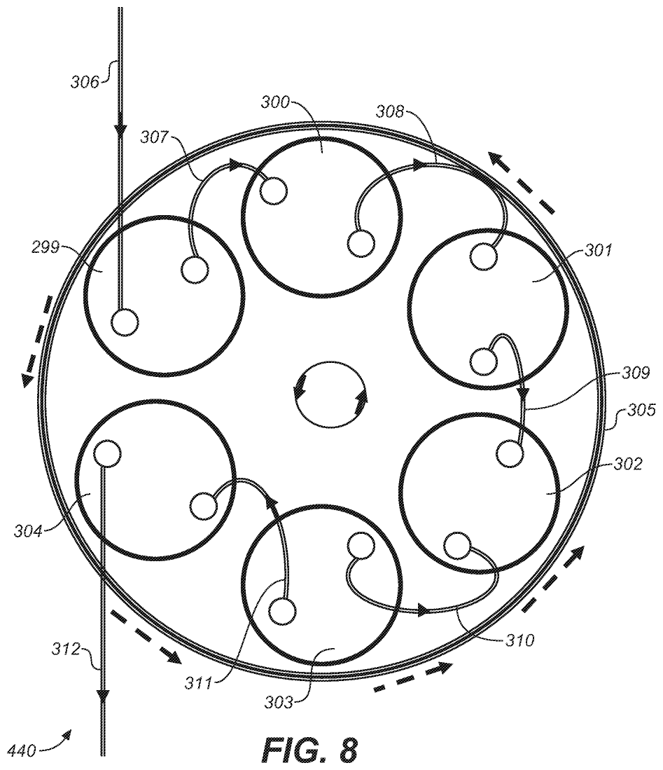

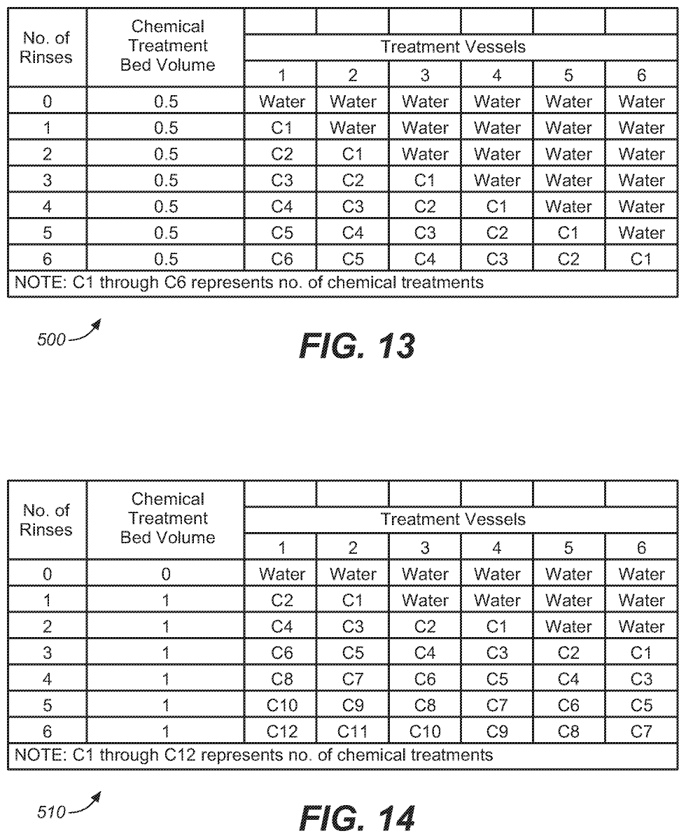

FIG. 8 shows an embodiment of a semi-continuous chemical treatment system for the present invention using six water tanks 299, 300, 301, 302, 303 and 304 respectively, each having a one bed volume. The tanks are disposed on a circular turntable conveyer 305 and use a 0.5 bed volume chemical treatment tank of acid. [It will be understood by those with skill in the art that prior to chemical treatment at this stage of the process, cation resin and/or anion resin will already have been transferred to these six tanks through outlet conduits 73 and 79 of the separation system shown in FIGS. 2-3. [The 0.5 bed volume of chemical entering the vessel 299 through conduit 306 displaces all of the 0.5 bed volume of water present in the vessel. Displaced water enters vessel 300 through conduit 307, thereby displacing water already present in the vessel. Water displaced from vessel 300 passes through conduit 308 and enters vessel 301, in turn for each successive tank, through vessels 302 and 303, and corresponding conduits 310 and 311, until the water in vessel 304 is displaced and discharged through conduit 312. Water received at the end of the cycle is 0.5 bed volume of waste water. During this process vessel 299 is chemically treated once with the 0.5 bed volume of chemical, and the remaining tanks with water only. [See also Table 1, 500, FIG. 13.] After chemical treatment, the regenerated resins may be employed for commercial and industrial applications in well-known ways.

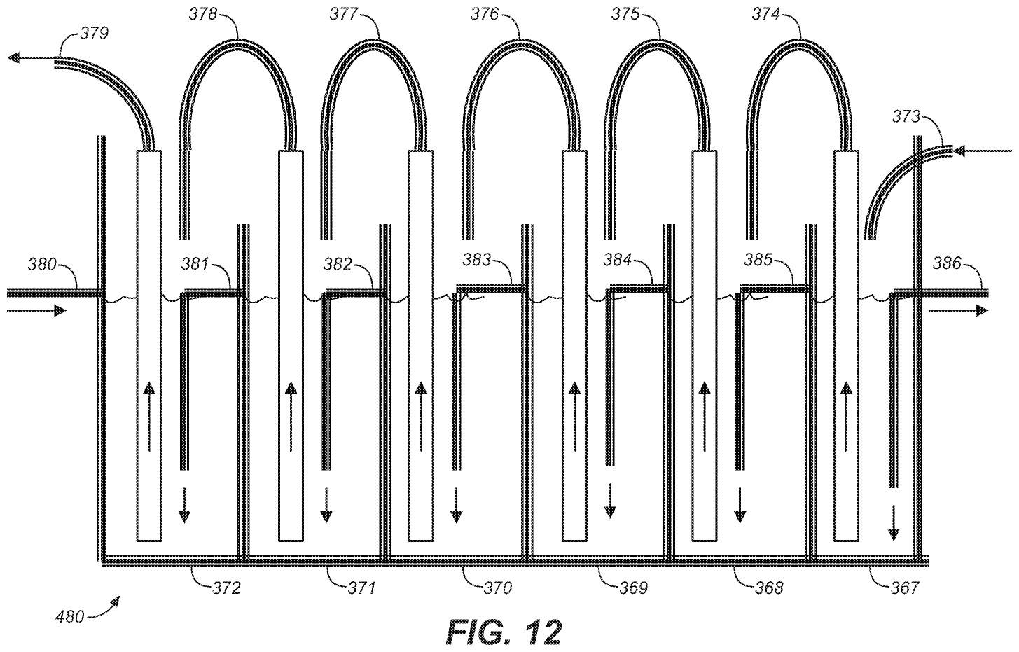

The process described for the turntable conveyor is shown in a linear configuration in FIG. 12, wherein six water tanks 318, 317, 316, 315, 314 and 313 respectively, each have a one bed volume. The tanks are disposed on a linear conveyor 319 and use a 0.5 bed volume chemical treatment tank of acid. The 0.5 bed volume of chemical enters vessel 318 through conduit 326 displaces all of the 0.5 bed volume of water present in the vessel. Displaced water enters vessel 317 through conduit 325, thereby displacing water already present in the vessel. Water displaced from vessel 317 passes through conduit 324 and enters vessel 316, in turn for each successive tank, through vessels 315 and 314, and corresponding conduits 322 and 321, until the water in vessel 313 is displaced and discharged through conduit 320. Water received at the end of the cycle is 0.5 bed volume of waste water. During this process vessel 318 is chemically treated once with the 0.5 bed volume of chemical, and the remaining tanks with water only. (Again, see Table 1, 500, FIG. 13.]

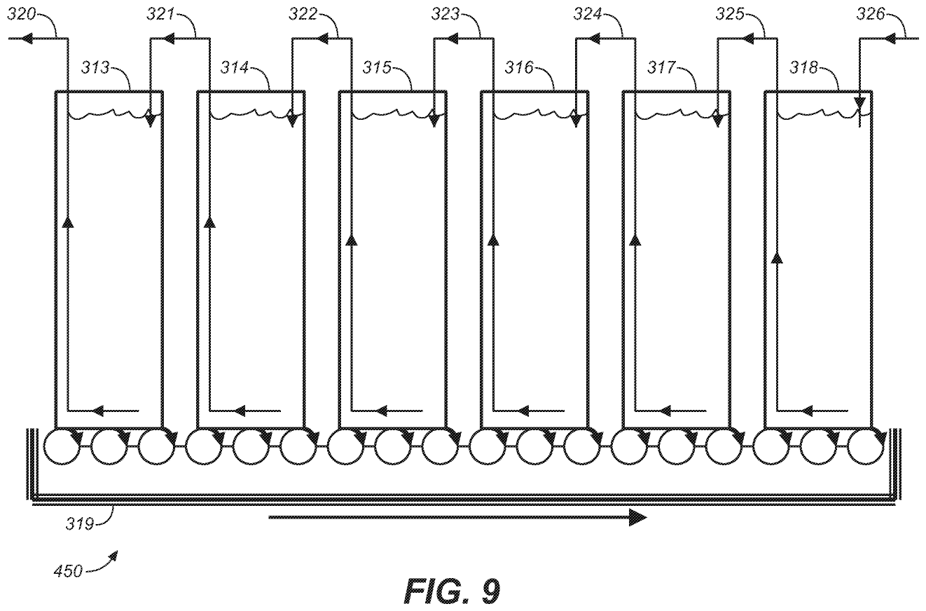

In the same FIGS. 8 and 9, considering another 0.5 bed volume of chemical treatment process of the vessels. Vessel 299 contains 0.5 bed volume of chemical while all other vessels contain water. Chemical enters vessel 299 through conduit 306 for the second time. Chemical already present in vessel 299 is now displaced by the new chemical entering the vessel and thus rinsing it chemically two times in the process. Displaced chemical goes into vessel 300 through conduit 307 displacing the water present in it. Vessel 300 is thus chemically treated once with chemical. The displaced fluid from vessel 300 passing through conduit 308 then displaces fluid from the other vessels, in order, and the spent chemical is then discharged from vessel 304 through conduit 312, the end of this stage of the process.

It is important to note that every time the vessels are rinsed with chemical, an additional vessel is chemically treated while the vessel(s) previously chemically treated are chemically treated once again. For instance, the first time a vessel is chemically treated, vessel 299 was chemically treated. The second time vessel 299 is chemically treated, vessel 299 is then twice treated and vessel 300 is once treated. (For the successive treatment schedule, again refer to Table 1, 500, of FIG. 13.] The successive treatment schedule is identical, as described above, for the linearly arranged tanks of the embodiment 450 of FIG. 9.

The chemical treatment process continues for 3 more 0.5 bed volume cycles of each of the chemical treatment tanks in a similar fashion, wherein the chemically treated water from a vessel is displaced by chemical after each rinsing. Table 1 illustrates the number of treatments through sixth rinse cycles. In this table, vessel 299 corresponds to vessel 1 (meaning location 1), vessel 300 corresponds to vessel 2, vessel 301 corresponds to vessel 3, vessel 302 corresponds to vessel 4, vessel 303 corresponds to vessel 5, and vessel 304 corresponds to vessel 6. (Again, the arrangement and numerical order of the linear array of vessels in FIG. 9 corresponds identically to vessels 1-6 in Table 1.)

Thus, until the sixth rinse in the chemical treatment process, i.e. use of the sixth 0.5 bed volume of chemical treatment tank, except for vessel 304, all other vessels have now been chemically treated at least once; with vessel 299 being chemically treated five times (since five rinsing have occurred), vessel 300 four times, vessel 301 three times, vessel 302 two times and vessel 303 one time.

When chemical enters vessel 299 for the sixth time, it rinses it six times, and displaced chemical rinses all other vessels one more time. Vessel 303, now treated chemically only once, has its chemical displaced by new chemical coming from vessel 302 through conduit 310 and its chemical content is thereby displaced into vessel 304 through conduit 311, thus rinsing vessel 304 once in the process. Vessel 304 is therefore also chemically treated once, and all six vessels are thus chemically treated at least once with chemical, while vessel 299 is chemically treated six times. The cycle is complete as to vessel 299, and it is taken out from the chemical treatment operation. All other vessels are then moved one place forward on the conveyer (linear or turntable), placing vessel 300 in the vessel 1 location, vessel 301 in the vessel 2 location, and so on. A new vessel, call it vessel X, is put in the vessel 6 location in place of vessel 304 in the order, and the chemical treatment cycle continues.

After this substitution, each chemical rinse cycle involves chemically treating a vessel six times in the process, removing the vessel from the conveyer, and carrying on. From this it will be appreciated that a 0.5 bed volume of chemical will rinse a vessel once, while a 1 bed volume of chemical will rinse the vessel twice. Thus, six chemical treatments of tanks using a 0.5 bed volume of chemical will rinse a vessel 6 times. See, again, Table 1 500, FIG. 13.

Still referring to FIGS. 8-9, instead of using a 0.5 bed volume of chemical treatment tank, if a 1-bed volume of chemical if employed, the vessel at location 1 will be chemically treated twice, and the vessel at location 2 will be chemically treated just once. Thus, by repeating the process six times, the vessel at location 1 will be chemically treated 12 times, the vessel at location 2 eleven times, the vessel at location 3 ten times, the vessel at location 4 nine times, the vessel at location 5 eight times, and the vessel at location 6 seven times. Thus, by carrying out six chemical rinses, the vessels are chemically treated 12 times instead of 6. Now see Table 2, 510, in FIG. 14.

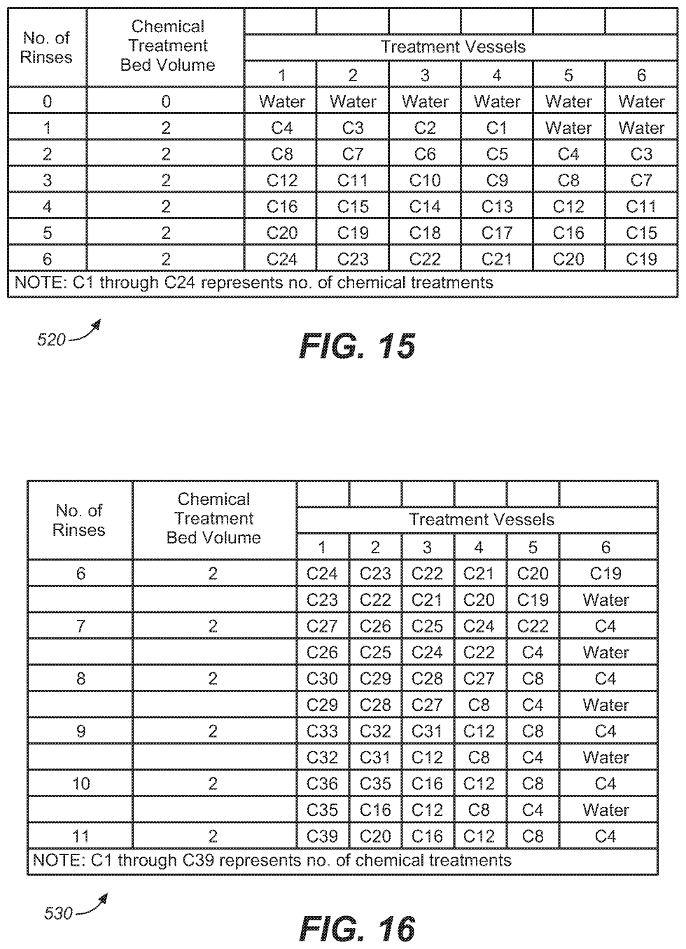

Similarly in the case of a 2 bed volume of chemical in the chemical treatment process, after a first injection of 2 bed volume of chemical into the vessels, the vessel at location 1 is chemically treated four times, the vessel at location 2 three times, the vessel at location 3 two times, and the vessel at location 4 once. The vessel at locations 5 and 6 will still be filled with chemically treated water. When the vessels are chemically treated for the second time by the 2 bed volume of acid, the vessel at location 1 will have been chemically treated eight times, the vessel at location 2 seven times, the vessel at location 3 six times, the vessel at location 4 five times, the vessel at location 5 four times, and the vessel at location 6 three times. Thus, by repeating the process six times, the vessel at location 1 will have been chemically treated 24 times, the vessel at location 2 23 times, the vessel at location 3 22 times, the vessel at location 4 21 times, the vessel at location 5 20 times, and the vessel at location 6 19 times. The vessel at location 1 after being chemically treated 24 times is removed from the conveyer and a new vessel is added to location 6, while other vessels are moved one location forward in the order. [See Table 3, 520, FIG. 15.]

After six chemical rinse cycles with the vessels at each location moved one place ahead, the vessel at location 1 will have been chemically treated 23 times, the vessel at location 2 chemically treated 22 times, the vessel at location 3 21 times, the vessel at location 4 20 times, the vessel at location 5 19 times, and a new vessel at location 6 zero times. After each rinsing of the vessels by a 2 bed volume of chemical, vessels will have been chemically treated 4 more times, as shown by Table 4, 530, FIG. 16, and a new vessel will be added to location 6 with all others being moved forward one place. Also, note that after the seventh rinsing, the vessel removed from the conveyer will have been chemically treated 27 times. After eighth rinsings, the vessel removed will have been chemically treated 30 times, and so on until the end of the eleventh rinse, when the vessel removed will have been chemically treated 39 times.

From first rinse to the eleventh rinse, the operation is named as “Transitional Chemical Treatment (TCT)”. Now, from TCT onwards, after each rinse, vessel we take out from location 1 is chemically treated 24 times and follows a consistent pattern (as shown in chart 5).

The foregoing schedules related to a generalized chemical treatment process of spent ion exchanged resin. In practice, chemical treatment carried out in a similar fashion but with a chemical treatment tank containing a 2 bed volume of the acid. An industrial 1 bed volume is 3.6 cubic feet, which is approximately equal to 27 gallons. Thus, a 2 bed volume equals 54 gallons. A 1 bed volume chemically treats the resin 2 times; thus a 2 bed volume rinses it 4 times, as shown in Tables 4 and 5.

In the present state of the art, only one chemical treatment vessel is employed. In the present invention, in a six vessel configuration, five vessels are in process while one vessel is pulled from the set, thus utilizing half the amount of bed volume to pass through. Consequently, the production rate of this invention is doubled compared to the existing state of art. Notably, six vessels provide a practical optimum number of vessels for implementing the invention. However, according to this invention, the number of vessels could range from 2 to anything greater than 2.

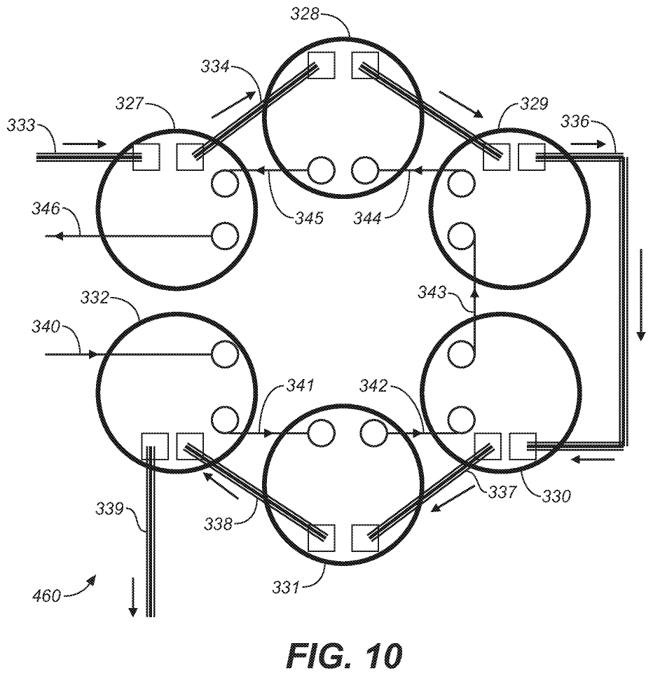

FIGS. 10, 11 and 12 show three different arrangements of the inventive system. FIGS. 13 and 14 illustrate the inventive apparatus configured for stationary placement and having six discrete vessels, either arranged linearly or circularly, while FIG. 15 shows the system having a unitary (single) tank with six (6) compartments.

In FIG. 13, a top plan view of an embodiment of the invention is shown with six vessels 327, 328, 329, 330, 331 and 332. There are seven resin transfer systems 333, 334, 335, 336, 337, 338 and 339. The resin transfer systems move resin from vessel to vessel or compartment to compartment. There are seven conduits designed to flow regenerant chemical in the direction opposite the resin transfer flow, utilizing conduits 340, 341, 342, 343, 344, 345 and 346.

In operation, spent resin is introduced into vessel 327 for regeneration through the resin transfer system 333, and regenerated resin is discharged from vessel 332 utilizing transfer system 339.

Similarly, regenerant chemical is introduced into vessel 332 utilizing conduit 340, while spent regenerant chemical is discharged from vessel 327 through conduit 346.

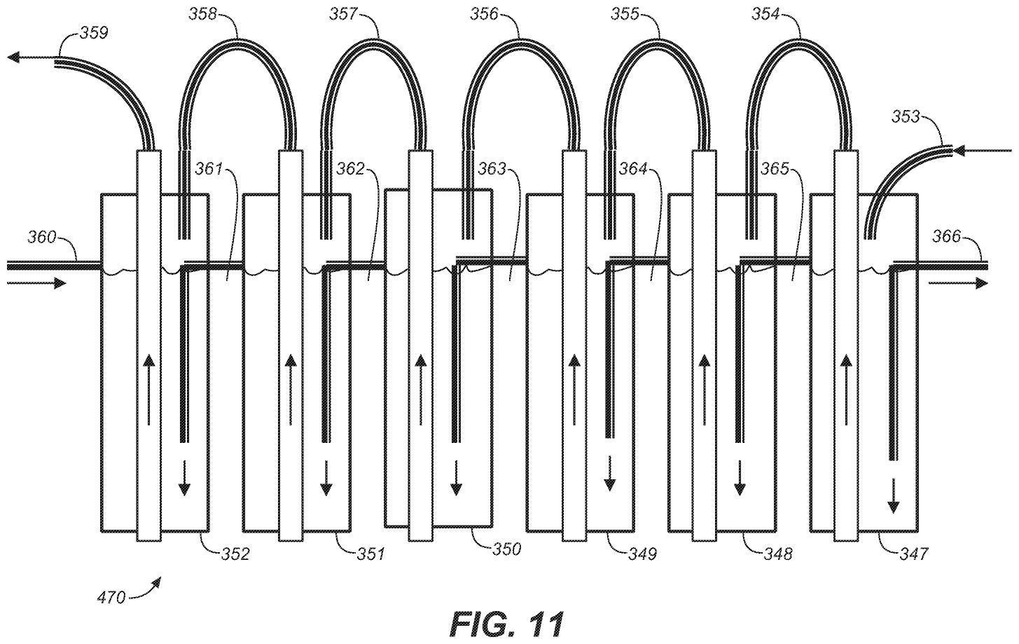

The linearly configured systems of FIGS. 11-12 operate in the same sequence. Taking FIG. 11 first, resin transfer is initiated through resin transfer system 353 into vessel 347 and flowing through each vessel in succession, 348 through 352 through conduits 354 through 358, until discharge through resin transfer system 359. Regenerant chemical is introduced to move through the vessels for flow in the opposite direction, beginning with vessel 352 as introduced by transfer system 360 and proceeding through the vessels in succession, 352 through 347 through conduits 361 through 365, until being discharged from vessel 347 through transfer system 366.

In a unitary system, as seen in FIG. 12, resin transfer is initiated through resin transfer system 373 into vessel 367 and flowing through each vessel in succession, 368 through 372 through conduits 374 through 378, until discharge through resin transfer system 379. Regenerant chemical is introduced to move through the vessels for flow in the opposite direction, beginning with vessel 372 as introduced by transfer system 380 and proceeding through the vessels in succession, 382 through 387 through conduits 381 through 385, until being discharged from vessel 387 through transfer system 386.

Both continuous and semi-continuous systems utilize existing material handling technologies employed in a conveyer belt system. In embodiments, three types of conveyer belts are preferably employed, including a merry-go-round table, a roller conveyer belt, and either a rigid screw conveyer or a flexible conveyer. However, several other types of conveyer belts are contemplated, including gravity conveyor, gravity skate wheel conveyor, belt conveyor, wire mesh conveyors, plastic belt conveyors, bucket conveyors, flexible conveyors, vertical conveyors, spiral conveyors, vibrating conveyors, pneumatic conveyors, electric track vehicle systems, belt driven live roller conveyors, line shaft roller conveyor, chain conveyor, screw conveyor or auger conveyor, chain driven live roller conveyors, and the like.

Looking now at the entire inventive regeneration process, backwash wastewater system employed in the present invention consists of a series of filtration processes. Unlike prior art systems, the present invention uses micro-filtration as a final filtration operation. The output product of micro-filtered water exceeds the water quality of city water with respect to particulates concentration. This addresses the problem that a mere 2-5% of backwash wastewater is disposed with full regulatory agencies compliance.

As is well known, backwash is critical for newly manufactured resin because it has undesired fine particles (resin fines) and contains monomer (TOC) in the bead matrix structure of the resin. Such newly manufactured resin needs excessive backwashing. In prior art systems, backwashed water cannot be reused due to high TOC. But using the inventive system, backwashed water can be reused up to 70 to 80%. This is uniquely achieved by employing double pass reverse osmosis technology which removes larger molecular weight monomer (TOC) from the backwash as RO concentrate (20-30%) while the RO product water (70-80%) with lower TOC is recycled for backwash operation.

Advantageously, the inventive system operates at lower pressures than prior art systems. Current regeneration apparatus and systems operate at high pressures (e.g., 30 to 60 psi) for all regeneration phases including backwash. This tends to compress polymeric ion-exchange beads from all sides. Because polymeric ion-exchange resin beads have some elasticity, they tend to shrink under pressure, thereby reducing surface exposure, reducing the metric space, and reducing the degree to which monomer (TOC) is leached from the resin in regeneration. In the present invention, ion-exchange regeneration is carried out in open top vessels under close to one atmosphere of pressure. Accordingly, TOC trapped in resin beads has more open space and more readily leaches out. Thus, the inventive system provides a more efficient way to remove the TOC out of newly manufactured resin.

Still further, in current regeneration technology, the use of backwash water quality is not controlled with respect to its pH, its TDS (total dissolved solids), and its controlled ionic species, such as calcium and magnesium. For example, different regions of a water source may have various amounts of pH, TDS, and calcium and magnesium content. Consequently, in the backwash operation, there is no consistency, which adversely affects the efficiency of the backwash operation. By controlling the predetermined parameters of backwash water quality, a consistent and reliable backwash operation can be achieved. Since 100% of the water is recycled in this operation, inlet backwash water quality is precisely adjusted and the concentration of calcium and magnesium is maintained using a water softening technique. The water softening is conducted after employing filtration and micro-filtration, as discussed in connection with the backwash system shown in FIGS. 1-2, above. This technique has a significant advantageous effect in the subsequent separation process in the overall ion-exchange regeneration process.

Backwash: Looking once again at FIGS. 1-3, the backwash process in this invention utilizes two tanks (vessels 1 and 2 in FIG. 1, and vessels 30, 31 in FIGS. 2-3), one for backwashing the resin and other tank for the collection of overflowing water from the first tank. The second tank is in fluid communication with a pump and micro-filtration apparatus. The micro-filtration produces two streams of effluent 8, 9, and 37, 38, respectively for FIGS. 1 and FIGS. 2-3. One concentrate effluent has high concentration of contaminants and low volume, and it is returned back to the second tank. The other effluent is “product water” and is free from particulate contaminants. This effluent is the passed through a water softener 10 to remove calcium and magnesium from the water. As stated before, water quality of this is adjusted to pH and TDS and quality data is measured using sensor 12 and the data recorded on the monitor 13. This effluent is split into two streams 14, 16 and 43, 47, respectively in FIGS. 1, and 2-3, and the second stream 16 enters at the bottom of the first tank at a rate of 7-12 gpm uniformly all over the area to provide backwash pressure for resin in the first tank, vessel 1. The other stream is utilized to eject spent resin into first tank for the backwash operation.

Resin Separation: Extant regeneration systems for a mix bed ion-exchange system separate resin in a single vessel in a batch form. The aqueous media employed to effect the separation is not precisely controlled for pH, TDS, or calcium and magnesium concentration. The present invention the quality of the aqueous media is tightly controlled in both backwash and separation. The system thus provides an enhanced process and product for the separation and isolation of anion and cation exchange resins, utilizing and recycling a controlled quality of aqueous media, which is particularly well-suited for treating recycled water with cation exchange resin in sodium form. The controlled quality of water is itself novel, and so too is the use of multiple tanks, either in a semi-continuous resin separation process or in a continuous resin separation process.

Therefore, it bears noting that the present invention includes three innovative features: (i) controlling the quality of aqueous media is employed in both backwash as well as ion-exchange resin separation; (ii) a semi-continuous separation process and product are provided; and (iii) a continuous separation process and product.

Additionally, extant spent ion-exchange resin in regeneration systems is backwashed with city water. The quality of water varies markedly from place to place and from season to season. Water quality is not maintained is existing systems, and this has a significant influence on the resin separation process.

In the present invention both backwash water and resin separation quality is maintained with respect to both TDS and the constituents of TDS (mineral content). The inventive system also controls sodium ion concentration and eliminates other ions, such as calcium and magnesium. In so doing, sodium ion concentration competes with calcium and magnesium for exchanges on the cation exchange resin. Therefore, the spent ion-exchange resin acquires ionic uniformity due to the sodium ions. Once the spent cation resin is exposed to the anion cation separation in aqueous media, the fuzzy band phenomenon is minimized and the spent anion resins and spent cation resins separate distinctly.

Current regeneration systems do not control the quality of water employed for resin separation. Thus, instead of obtaining a sharp line separating cation and anion resin, existing systems yield a fuzzy band. For a continuous separation to work the density of the cation-exchange resin must be lower (by 0.01-0.05 g/ml) than the density of the mixed-bed cation-exchange resin, and the particle size must be approximately equivalent for both. Additionally, the density of the anion-exchange resin must be be higher (by 0.01-0.05 g/ml) than that of the mixed-bed anion-exchange resin, the particle size being equivalent for both.

Mix bed resin separation has two fundamental objectives. The first is to acquire uniform density. It is very important to note that the fuzzy band between cation and anion resin is due to varying degree of densities of exhausted anion and cation resins. The existing state of art deals with this issue by shocking the resin with a brine treatment in which both anion and cation resin acquires uniformity. It does so, however, at the cost of swelling the resin. Therefore, the brine treatment is infrequently employed. In the present invention, by contrast, rather than shocking the resin with brine, water quality is maintained by recycling the water through a water softener, and this promotes the needed uniformity of cation resin to yield uniformity within the cation resin matrix. This consequently leads to sharper separation between mix bed resins.

Extant system have failed to address a second fundamental concern for mix bed ion exchange resin separation: fluidizing media (water). Typically, the fluidizing media is water. In the present invention, the velocity of water in the vessels is maintained, and this has a direct impact on the density of particles. For example, lighter particles are elevated to a higher height within the separation vessels than are heavier particles. This principal advantage of the inventive system resides in the fact that water velocity is maintained in such a way that the finest dirt particles and fine resins are carried away with the velocity of water, thereby leaving behind anion and cation resin (already separated) in the vessel. The anion resin, being lighter, is lifted to form an upper layer within the separation vessel, while heavy cation resin is elevated below the anion resin layer to form a lower spent resin layer.

Semi-continuous resin separation system: Existing ion-exchange separation is conducted as a batch operation, which is accomplished in a single tank setup. The mixed spent ion-exchange resin is transferred into a vessel, and upon separation it is either treated in a batch manner in a same vessel or transferred into anion and cation regeneration vessels for batch treatments, respectively. However, it is known to separate mixed ion-exchange resin in a semi continuous manner, and implementation in a semi-continuous system (FIGS. 2, and 8-9) enables a full separation for both anion and cation exchange resin. This results in high capacity regeneration and therefore, the overall cost of deionized water operation is reduced. Summarily, spent ion exchange resin enters into the semi-continuous system while anion and cation exchange resins are being tapped out from two other sources, simultaneously in a continuous or semi-continuous manner.

Standard industry practice has demonstrated that using a single tank (batch) separation causes 5-10% of anion to be mixed with cation, and vice versa. This results in an overall 10-20% loss of resin capacity. However, the present invention provides a complete (100%) separation of cation and anion. The semi-continuous separation system of the present invention utilizes multiple vessels, preferably three or more vessels, as shown in FIGS. 2-3. The three vessel, semi continuous concept of ion-exchange resin separation (FIG. 2) can be described as follows:

In a spent mixed bed separation process according to the present invention, backwashing with two vessels FIGS. 1, 4-7), is followed by separation using three vessels (FIGS. 2-3). The vessels can be configured linearly or in a circle. Spent mixed ion-exchange resin after backwash is transferred into the central (first separation) vessel 59 maintaining 40%-60% freeboard. The entire content of the central vessel is then fluidized and agitated with clean dry and oil-free air. The entire mass is then allowed to settle under gravity after stopping the air agitation. The cation exchange resin, having higher density particles than anion exchange resin particles, settles in the bottom of the vessel, while the anion exchange resin, having low density particles, forms a top layer in the central vessel. Due to the controlled quality of the aqueous media, the intermediate fuzzy band width is small and distinctly visible.

Descending down the fuzzy band, one can observe the anion exchange resin contamination gradually decreasing to 0%. Thus, at the bottom of the first separation vessel, almost 100% cation exchange resin is found. Similarly, ascending from the fuzzy band, the cation exchange resin contamination gradually decreases to 0%. Thus, the top layer consists of almost 100% anion exchange resin.

Strictly speaking, there is no sharp separation line between anion and cation exchange resin in single vessel operations. In fact, there is always a varying amount of fuzzy band. In the present invention, however, by using three vessels in the separation process, the central vessel performs similarly to a single vessel in extant batch systems. In the present invention, the first separation vessel 59 (the central vessel) offers a coarse resin separation.

But after separation in the first separation vessel, the lowermost concentrated cation exchange resin is transferred into the second separation vessel 60 while the uppermost concentrated anion exchange resin is transferred into the third separation vessel 61. In this manner, the second and third separation vessels offer finer resin separation. Upon accumulating enough cation exchange resin with very little contamination of anion exchange resin in the second separation vessel 60, the resin is then fluidized and agitated with clean dry and oil-free air and then allowed to settle under gravity after stopping the air agitation, resulting in 100% cation exchange resin in the bottom. This is then removed for the next stage of the regeneration process, and a similar treatment is applied to the anion exchange resin.

The separation process of the present invention is conducted semi-continuously and the 100% separated resins are also tapped out in a semi-continuous manner from their respective tanks. It is important to note that the uppermost resin in the third separation (left) vessel 61 has a contamination of cation resin, while the second separation (right) vessel 60 has a contamination of anion resin, therefore both the upper layers of these two tanks are transferred to the first separation vessel 59 (the central tank), for another separation pass.

Continuous resin separation system: In embodiments, all of the inventive systems control the quality of the aqueous media in a backwash operation to achieve an optimum degree of uniform density of cation resin and/or anion resin. Further, the aqueous media is maintained in dynamic mode with a specified velocity that separates anion resin from cation resin, as well as resin fines and dirt. At a lower velocity (2-4 gpm/ft²), spent ion-exchange mix-bed resin with all three components (anion resin, cation resin, and undesired resin fines and dirt particles) are introduced. Cation resin is initially separated from anion resin and resin fines plus dirt particles and remains in the bottom of the apparatus. Then the aggregate mixture of anion and resin fines plus dirt particles enter into a higher velocity (4-7 gpm/ft²) zone which tends to separate and retain anion resin above a cation resin layer. Finally, the resin fines plus dirt particles enter into a higher velocity (7-12 gpm/ft²) zone which carries away these undesired particles. The overflow enters into adjacent vessel or tank. [See FIGS. 5-7.]

In various embodiments, there are four vertical resin separation methods used to produce dynamic water flows at different velocities in single vessels: (a) single header for continuous water flow inlet to the resin separation vessel (FIG. 4); (b) single header for continuous water flow inlet to the resin separation vessel with mechanical agitator (FIG. 6); (c) multiple headers for continuous water flow inlet to the resin separation vessel (FIG. 2); and (d) multiple header for continuous water flow inlet to the resin separation vessel with mechanical agitators (FIG. 3).

In an embodiment (FIG. 3), the continuous ion exchange separation system of is described in this invention with five vessels, two vessels for backwash plus three vessels for separation. The configuration may be the same as that of the semi-continuous embodiment. The five tanks are equipped with interconnecting overflows from the top at the same level, which allows the overflow from the other four vessels into vessel 30. All four vessels are maintained with designed gpm flow rate in the upward direction to achieve continuous dynamic condition. The mechanical agitators shown are variable speed.

The five tank implementation combines the backwash operation with the resin separation operation, thereby controlling the quality of the aqueous media in each phase. Vessel 31 receives continuously spent mix-bed resin for regeneration. The resin is backwashed and transferred continuously into the central vessel for separation. The central vessel has a uniform flow of water at a rate of 2-4 gpm/ft². Due to the mechanical agitation and the upward flow of water, cation resin tends to acquire lower layer. The layer above the cation resin layer is acquired by anion resin, and resin fines and dirt particles are carried out through the overflow into vessel-30. From the lowermost zone of cation resin, the resin is transferred continuously for regeneration with acid treatment. Similarly from the uppermost zone of anion resin, the resin is transferred continuously for regeneration with sodium hydroxide treatment.

While the five vessel configuration is preferred, the process can be performed with one to any number of vessels (where x is a numerical number from 1 to an indefinitely high number constrained only by practicality and economics). Vessel 30 is designed to hold a certain fixed amount of water, which is continuously used and recycled back, maintaining it to a constant level and controlled chemistry. Water from Vessel 30 is continuously pumped through micro-filtration system and water softening system to maintain a designed flow rate of controlled water (pH, TDS and low calcium and magnesium). The quality controlled water enters at the bottom of vessel 31 uniformly. A clean dry compressed air is also introduced to promote agitation within vessel 31 (if required). Spent mix bed ion exchange resin is then introduced in the tank continuously at a steady flow rate. The gentle agitation of spent ion exchange mixed resin in vessel 31 allows the undesired particles to release, which then co-flows with water and overflows into vessel 30. Water from vessel 31 is continuously passed through micro-filtration to remove particles, and clean, particle-free water recycles back to vessel 30. This operation is similar to the backwash operation; but it provides an additional opportunity to remove resin fines and other particulates from the ion-exchange resin, which might otherwise have been left in the backwash operation. Thus, using the present invention, backwash and resin separation operations can be combined.

Spent resin from vessel 31 is continuously drawn into vessel 59 with a specially designed header. In the continuous operation embodiment, a variable speed mechanical agitator is installed in all five vessels (see FIG. 3). The flow of spent resin from vessel 31 to vessel 59 undergoes resin separation due to density under designed flow rate. The cation resin acquires the lower layer, and the anion resin acquires the top layer. The designated flow rate promotes the release of resin fines and dirt particles to carry and overflow into vessel 30. The cation resin is continuously transferred to vessel 60 from the bottom of vessel 59. Similarly, anion resin is continuously transferred to vessel 61 from the topmost anion layer situated above the cation layer in vessel 59. Both vessels 60 and 61 continuously collect cation and anion resins, respectively. At this point, both vessels 60 and 61 have 95 to 100% pure cation and anion resins. The mechanical agitators in these tanks and uniform flow of designed water from bottom in the upward direction would further separate remaining anion from cation resins. At this stage, 100% cation resin is removed from the bottom of vessel 60 and 100% anion resin from the top of vessel 61 continuously, for chemical treatments respectively.

In an embodiment, a single vessel may be employed. This concept is based on variable upward velocity achieved by multiple headers, wherein the velocity of fluid flow varies throughout the volume of the tank. In the foregoing embodiments, the space within the treatment vessels is constant from the bottom to the top of the vessel. Therefore, the velocity of aqueous media remains constant throughout the height of the tank. To obtain variable velocities at different heights of the tank, it is necessary to introduce two or more streams of water in the tank at different heights. Therefore, if a 3 gpm flow is introduced in the bottom of the tank, and at a certain height from the bottom another stream of water is introduced at a velocity of 2 gpm, then beyond the second flow of water the velocity increases to approximately 5 gpm. This concept is utilized in the present invention by introducing two or more fluid flows into the tank at different heights to create variable velocity zones in the tank and thereby to promote resin separation. At lower velocities, cation resin acquires the lower layer and anion resin at higher velocity zone acquires a second layer, while at a maximum velocity, resin fines and dirt particles are carried away. FIG. 6 illustrates this variable speed concept for both backwash and resin separation operations utilizing a single tank. Again, water chemistry is also tightly controlled in this concept.

The invention is also based on variable upward fluid flow velocities achieved by introducing multiple dead spaces at different heights. These dead spaces can be introduced with variously shaped baffles, FIGS. 4-7. In an embodiment, dead space may be introduced by installing single or multiple shaped pipes or cylinders within the vessels. The different pipe/cylinder diameters create different dead zones and induce different fluid flow rates.

Mechanical mixing can be achieved using the variable speed agitators, mentioned above, or by using vibrators of frequency of 200 to 400 Hz. Similarly, effective local hydraulic dynamics can be generated with an ultrasound frequency probe of 1-20 MHz or a concrete vibrator core of 10k-15k vibrations per minute.

In all of the foregoing embodiments, vertical vessels are illustrated. However both backwash and resin separation may be accomplished using horizontally oriented tanks.

Chemical treatment: Chemical treatment of spent ion exchange resin is a third step of the ion exchange regeneration process. Previously, all acid and acid rinses are mixed, resulting in dilute acid waste. Similarly, all alkali and alkaline water are mixed to form dilute alkaline waste. Both acidic and alkaline wastes are then self-neutralized and disposed of without recovering acid or alkaline chemicals. The present invention enables the reuse and recycling of acid and alkali solutions.

In the inventive method, ion exchange resin and its regenerating chemical are in a dynamic state moving in opposite directions. Therefore, the spent ion exchange resin enters the apparatus at one end and leaves from the other end at which the regenerating chemical is introduced. Since the streams of spent cation or anion exchange resin flow is encountered with a flow of chemical solution moving in the opposite direction, it results into a dynamic chemical equilibrium. As a result, both cation and anion exchange resins are in contact with fresh chemical. The cation exchange resin, before being discharged from treatment vessel, is in contact with acid at the peak of maximum proton [H⁺] concentration, leading to the highest capacity regeneration of cation.

Similarly, the anion exchange resin, before being discharged from treatment vessel, is in contact with sodium hydroxide at the peak of maximum hydroxyl ion [OH] concentration, thereby leading to the highest capacity regeneration of anion resin. In consequence, the spent resin gradient decreases as it keeps coming into contact with fresher and fresher treating chemical.

Traditionally ion-exchange resin, such as cation and anion, are regenerated with dilute alkali and acid, respectively, after separation from a mix-bed. In the case of a batch chemical treatment, the resin capacity is directly proportional to the amount of acid or caustic used in the regeneration process. The present invention employs 9 lb./ft³ of either hydrochloric acid or sulphuric acid for cation-exchange resin regeneration, while it uses 8 lb./ft³ of sodium hydroxide for anion-exchange resin regeneration. Both chemicals are employed at 4-10% concentration. With this chemical treatment, anion-exchange resin gains 12,000 grain/ft³ and cation-exchange resin gains 18,000 grain/ft³ capacity.

Extant regeneration systems rinse the ion-exchange resin with a 2-4 bed volume of regenerating solution. For instance, 1 ft³ of ion-exchange resin requires 2-4 ft³ of chemical. However, 1 ft³ of resin has a space that will accommodate ½ ft³ of chemical. Therefore, 2-4 ft³ of chemical occupies 4-8 times the space between the resin, which amounts to 4-8 times rinsing with chemicals.

The present invention provides a 300% increase in contact of chemical with the resin, and the method provides for rinsing of the bed of ion-exchange resin 12-24 times, as opposed to existing state of the art—only 4-8 times. Consequently, more rinsing of ion-exchange resin with regenerant chemical results in shifting the chemical equilibrium towards higher regeneration capacity of the resin.

Standard industry practice dictates using either a single tank for chemical treatment or three tanks (including a resin separation tank, a cation treatment tank, and an anion treatment tank). In single tank batch operations, anion-exchange resin is treated with sodium hydroxide solution at the bed separation area with an upward flow of chemical through the anion bed. The sodium hydroxide solution is discharged from the top of the tank, while acid is introduced at the resin separation area and moves downwards through the cation-exchanged bed. Spent acid solution is then discharged from the bottom of the tank. Since both the chemicals are in close proximity at the resin separation area, and due to diffusion of ions, there is some neutralization of chemicals, which results in their loss without any productive use in the regeneration system. This self-neutralization phenomenon is responsible for a loss of 5-15% chemical. There is no loss of chemical through self-neutralization when using the present invention.

The present invention conducts both chemical and slow rinses to recover and reuse 80-90% of regenerant chemical with only 10-20% disposal.

As noted, extant regeneration systems include regenerant chemicals in dynamic motion while the exchange resin is stationary in a single vessel. Since the resin bed is in stationary condition, the direction of regenerant chemical flow does not truly matter, i.e., whether it is upward to downward or otherwise. In the present invention, both regenerant chemical and resin beds are moving in opposite directions, providing improved system efficiencies.

Semi-continuous system: Referring again to FIGS. 8-9, there is shown a semi continuous system with multiple vessels (two to infinity). For practical purposes and for ease of operation, six vessels are well-suited to production operation. These vessels are placed on either circular merry-go-round type of circular table or conveyer belt type set-up. After deciding the direction in which the vessels are to be moved these vessels are interconnected in such a way that the flow of treating regenerant chemical moves in an opposite direction to that of the vessel movement.

Continuous system: Referring next to FIGS. 10-12, single or multiple vessels may be fixed in a linear arrangement or circular configuration. The vessels are equipped with transfer systems by which the resin is moved from vessel to vessel. Once the direction of resin from vessel to vessel is established, the flow of regenerant chemical is provided so as to flow in the opposite direction. Both operations are carried out simultaneously, resulting in regenerated resin discharging from one end of the apparatus and spent regenerant chemical discharging from the other end.

The present invention enhances the effective interaction between spent resin and regenerant chemicals. High frequency vibrators, ultra-high frequency, ultra-sonic wave generators, and electrolysis combined with membrane processes may be employed to achieve this end. High frequency vibrators are employed during the chemical reaction between regenerant chemical and spent resin. The high frequency energy from the vibrators tends to drive the chemical reaction in desired direction for high capacity regenerated resin.

In the present invention, spent chemicals are isolated in their original concentration without any dilution. On self-neutralization they precipitate calcium sulfate and magnesium sulfate. Both calcium sulfate and magnesium sulfate are easily filtered to produce recyclable products in industry. The filtrate consists of sodium chloride (brine solution), which is free from impurities. This can be employed in the water softening process. Therefore, the neutralized spent chemicals are environmentally friendly and are recycled, as opposed to being sent for disposal into a sewage system.

Slow and fast rinse operations: Existing regeneration systems use slow and fast rinses after chemical treatment. The entire slow and fast rinse volume along with spent regenerant chemical is mixed together, producing dilute regenerant chemicals. After self-neutralization they are disposed. In the present invention, slow rinse with an appropriate volume of rinsing deionized water results in full recovery of treatment chemicals and spent regenerant in their original concentration. Subsequent to slow rinse, the regenerated resins are subjected to fast deionize water rinse. The fast rinse deionized water effluent is 100% recycled. This unique approach of slow and fast rinse after chemical treatment results in 90% reduction in water required for the ion-exchange resin operation, and it simultaneously recycles 25% of regenerant chemicals.

The slow rinse/chemical recovery apparatus is similar to the semi-continuous and continuous chemical treatment apparatus. In the chemical treatment, regenerant chemicals are moving in the opposite direction to the ion-exchange resin. In the slow rinse/chemical recovery operation, the deionized water also moves in an opposite direction to the ion-exchange resin. The discharging deionized water from the continuous or semi-continuous apparatus contains the regenerant chemical in a maximum concentration with minimum contaminants, and this enables 100% reusability, thus full recycling. Similarly in the case of the fast rinse, the existing regeneration systems dictate self-neutralization and disposal.

Mixing anion and cation resins for mix-bed: In existing systems, the anion and cation exchange resin ratio is predetermined and placed in single vessel. As discussed before, this concept is appropriate for ion-exchange regeneration operation at a remote place where there is no centralized regeneration facility. However, in case of centralized on-site regeneration plan, the ratio between anion and cation exchange resin is constantly changing. Therefore, there are possibilities of incorrect ratio between anion and cation which may not meet client's specifications. In this invention, the ratio of anion and cation exchange resin is precisely accomplished with the help of anion and cation transfer system's flow rate. For example, if anion resin transfer system flow rate is adjusted to cation exchange transfer system's flow rate, the subsequent mixture would have 50 50% ratio of anion and cation resin. Similarly if anion resin transfer system flow rate is adjusted to 60%, the cation exchange transfer system's flow rate would be 40% in order to yield 60 40% ratio of anion and cation resin.

If the desired ratio of mix bed is not properly adjusted, then the mix bed will have an imbalance of anion and cation loading. If the cation loading is greater than anion loading, the throughput of such a mix bed is reduced, and if the anion resin is exhausted, then the pH of the deionized water will drop dramatically. Similarly, if the anion loading is greater than the cation loading, the throughput of such a mix bed is also reduced, and if the cation resin is exhausted, then the pH of the deionized water increases drastically. Therefore, in the case of a mix bed system, one has to adjust the cation/anion ratio carefully. The present invention provides better control in adjusting the desired ratio.

Resin transfer system: In current regeneration systems, resin transfer is accomplished employing water as the fluidizing media. A high current of water fluidizes resin, and then both fluidizing media as well as resin move through the process in the same direction. That technology cannot meet the goal of moving resin in an opposing direction to the regenerant chemical or rinsing water. Therefore, in the present invention, in semi-continuous operations the resin is transferred by moving vessels containing resin utilizing either: (a) a linear conveyer belt supporting and transporting the resin vessel; or (b) a circular “merry-go-round” platform designed and built with a central bearing. Either transport structure work well for semi-continuous transfer of vessels containing resin.

In the case of continuous resin transfer systems, an auger/screw technology is utilized. There are two types of augers that may be employed: (a) rigid augers; and (b) flexible augers. When using rigid augers the resin is transferred around the shaft of the auger. In the case of flexible augers, the resin is transferred through the center of the vessel. Both types are adequate for continuously moving resin in the desired location.

Final rinse and QA/QC: The inventive system includes a final rinse and QA/QC check prior to shipment, thereby obviating the need for a QC analysis at a recipient location.

From the foregoing it will be seen that in its most essential form, the inventive system is a novel continuous or semi-continuous regenerant chemical treatment system and method with several distinct embodiments that realize the same operational advantages. Those advantages are realized through the implementation of a system that enables (a) an extended period of regenerant chemical contact time with an ion-exchange resin without any adverse impact on the rate of production; (b) better and improved control over the chemical equilibrium between regenerant chemical and spent ion-exchange resin; which thereby achieves (c) a higher capacity of regenerated resin; (d) a reduction in regenerant chemicals required for such a process ranging from 50 to 70% over existing technology; (e) increased the throughput requiring fewer regeneration operations during the life cycle of the resin; and (f) an increased lifespan for the resin itself of 25 to 30%. Correspondingly, there are reductions in service and labor required for the end user enterprise.

What is claimed as invention is:

1. A continuous or semi-continuous ion-exchange resin regeneration system, comprising:
a backwash subsystem for a mix bed ion-exchange resin to dislodge and release resin fines, particles, and cations and anions adhering to the spent mix bed resin and to fluidize the spent mix bed resin, said backwash subsystem including at least one backwash vessel in fluid communication with a make-up water supply and having a backwash outlet;
a mix bed resin separation and isolation subsystem for separating and isolating mix bed resin into anion and cation exchange resins, said separation and isolation subsystem including at least one resin separation and isolation vessel in fluid communication with said backwash outlet to receive fluidized resin output from said backwash subsystem;
a regenerant chemical treatment subsystem in fluid communication with said separation and isolation subsystem outlet to receive separated and isolated fluidized spent resin output from said separation and isolation subsystem, said chemical treatment subsystem including at least one chemical treatment vessel having a regenerant chemical inlet for receiving a flow of regenerant chemical, and a regenerant chemical outlet, a spent resin inlet for receiving a flow of fluidized spent resin, and a spent resin outlet, said chemical treatment subsystem configured such that the fluid flow of regenerant chemical through said at least one chemical treatment vessel and the fluid flow of said fluidized spent resin are in opposing directions.

2. The ion-exchange resin regeneration system of claim 1, wherein said at least one chemical treatment vessels includes a plurality of stationary chemical treatment vessels configured in a generally circular arrangement and in fluid communication with one another for the transfer of both chemical regenerant and fluidized spent resin between adjoining vessels.

3. The ion-exchange resin regeneration system of claim 1, wherein said at least one chemical treatment vessel includes a plurality of movable chemical treatment vessels configured in a generally circular arrangement and disposed on a rotatable material handling merry-go-round conveyor and in fluid communication with one another for the transfer of both chemical regenerant and fluidized spent resin between adjoining vessels.

4. The ion-exchange resin regeneration system of claim 1, wherein said at least one chemical treatment vessels includes a plurality of stationary chemical treatment vessels configured in a generally linear array and in fluid communication with one another for the transfer of both chemical regenerant and fluidized spent resin between adjoining vessels.

5. The ion-exchange resin regeneration system of claim 1, wherein said at least one chemical treatment vessel includes a plurality of chemical treatment vessels configured in a generally linear arrangement and disposed on a linear material handling conveyor and in fluid communication with one another for the transfer of both chemical regenerant and fluidized spent resin between adjoining vessels.

6. The ion-exchange resin regeneration system of claim 1, wherein said backwash vessel includes a mechanical or air agitator or a combination thereof.

7. The ion-exchange resin regeneration system of claim 1, wherein said backwash subsystem includes at least two vessels, including a recycled water vessel and a backwash vessel.

8. The ion-exchange resin regeneration system of claim 1, wherein said backwash subs

9. The ion-exchange resin regeneration system of claim 1, wherein said backwash subsystem further includes a water quality control system for controlling include pH, total dissolved solids, and multi-valiant cation concentration.

10. The ion-exchange resin regeneration system of claim 9, wherein said water quality control system includes a micro-filter and a water softener.

11. The ion-exchange resin regeneration system of claim 1, wherein said separation and isolation subsystem includes a mixed bed separation and isolation vessel, a cation separation and isolation vessel, and an anion separation and isolation vessel.

12. The ion-exchange resin regeneration system of claim 11, wherein:
said mixed bed separation and isolation vessel is fluid communication with said water quality control system of said backwash subsystem and with said backwash vessel so as to receive backwashed mixed bed resin, wherein said first separation and isolation vessel further liquidizes and then uses differential densities of the respective ions to separate and isolate spent anion resin from spent cation resin through settling and thereafter uses a header located in an upper portion of said mixed bed vessel to capture and transfers isolated spent anion resin from an upper level in said mixed bed separation and isolation vessel to said spent anion separation and isolation vessel and uses a header to capture and transfer isolated spent cation resin from a lower portion of said mixed bed separation and isolation vessel to said spent cation separation and isolation vessel; and
wherein said anion and cation separation and isolation vessels further separate and isolate their respective spent resins through layering and separately transfer spent resin to said chemical treatment subsystem.

13. The ion-exchange resin regeneration system of any one of claims 1-12, further including final rinse.

14. A continuous or semi-continuous method of regenerating spent mixed bed ion-exchange resin, comprising:
(a) backwashing spent mixed bed ion-exchange resin in a backwash subsystem to dislodge and release resin fines, particles, and cations and anions adhering to the spent mix bed resin and to fluidize the spent mix bed resin, the backwash subsystem including at least one backwash vessel in fluid communication with a make-up water supply and having a backwash outlet;
(b) separating and isolating the fluidized mix bed resin into anion and cation exchange resins using a separation and isolation subsystem including at least one resin separation and isolation vessel in fluid communication with the backwash outlet to receive fluidized resin output from the backwash subsystem;
(c) chemically treating separated and isolate spent anion resin and spent cation resin using regenerant chemical using a chemical treatment subsystem from the separation and isolation subsystem, the chemical treatment subsystem including at least one chemical treatment vessel having a regenerant chemical inlet for receiving a flow of regenerant chemical, and a regenerant chemical outlet, a spent resin inlet for receiving a flow of fluidized spent resin, and a spent resin outlet, said chemical treatment subsystem configured such that the fluid flow of regenerant chemical through said at least one chemical treatment vessel and the fluid flow of said fluidized spent resin are in opposing directions; and
(d) repeating step (d) until the spent resin is suitable for recycling and reuse.
